(19) United States
(12) Patent Application Publication
(10) Pub. No.: US 2012/0134617 A1
(43) Pub. Date: May 31, 2012

(54) ROLLER BEARER FASTENING

(75) Inventors: Karl Keller, Hilchenbach (DE); Kurt Scheffe, Hilchenbach (DE); Arndt Schlösser, Huckelhoven (DE)

(73) Assignee: SMS SIEMAG AKTIENGESELLSCHAFT, Dusseldorf (DE)

(21) Appl. No.: 13/388,444

(22) PCT Filed: Aug. 10, 2010
(86) PCT No.: PCT/EP2010/004881

§ 371 Date: Feb. 1, 2012

(30) Foreign Application Priority Data
Aug. 12, 2009 (DE) 10 2009 037 273.3

(51) Int. Cl. F16C 43/04

(52) U.S. Cl. 384/562

(57) ABSTRACT

In a fastening system of a roller bearing, comprising a bearing unit (3) which has a roll pin (1) that is mounted in a roll pin bearing (8) therein and a threaded nut (9) that engages in a thread formed on the roll pin (1) or a tensioning anchor (5) fastened therein and fixes the bearing unit (3) on the roll pin (1), a solution is to be created that improves the self-locking anti-turn mechanism of a threaded nut holding a roll pin bearing in place. According to the invention, a bendable and movable partial section (9a) is formed on the threaded nut (9), which section can be moved, particularly bent, relative to the remaining part (9b) of the threaded nut (9) into a position creating surface pressure (15b, 16b) that acts opposite the remaining thread engagement of the threaded nut (9) in the thread.

The invention relates to a fastening system of a roll bearing, comprising a bearing unit with a roll neck supported in a roll neck bearing, and a threaded nut which engages in a thread formed at the roll neck or at a tension anchor fastened to the roll neck and which fastens the bearing unit on the roll neck.

Roll bearings are known in practice which comprise a bearing unit for a back-up roll of a roll stand which includes a chock with a roll neck bearing arranged in the chock, wherein the roll neck bearing is releasably fastened to a roll neck of the back-up roll, a tension anchor which is mounted coaxially in an end portion of the neck, and a screw cap disk which is mounted axially slidably on the tension anchor and which rests against a threaded nut which can be screwed on, on the one hand, and against the roll neck bearing, on the other hand. Such roll bearings are sold, for example, under the trademark MORGOIL®. All these roll bearings have a fastening system and/or element by means of which the roll neck bearing is fastened to the roll, wherein the roll is a back-up roll of a roil stand. The respective fastening system, by means of which a MORGOIL® bearing is held in its position on the roll neck in which it is pulled onto a back-up roll of a hot or cold rolling mill, sometimes includes threaded nuts. Because of the mechanical loads which occur during the rolling process which may be caused by initial passes, acceleration and deceleration of the rolls during the rolling process, measures must be provided for preventing the threaded nut from being separated during the rolling process from its position which secures the roll neck. In roll neck bearings which are in use today this is achieved by means of a positive engagement in which a screw penetrating the threaded nut is secured to an adjacent structural component whose position is fixed. For this purpose, it is necessary to bring the bore of the nut which receives the screw into a position which is in flush alignment with the corresponding threaded bore in the adjacent structural component whose position is fixed. For this purpose, the nut is initially tightened fast and is then once again turned back in such a way that it is possible to screw in the fixing screw through the bore of the nut in the corresponding threaded bore of the structural component and to thereby secure the nut against a counter rotation of the threaded nut and a separation caused as a result. This leads to the disadvantage that the initial pre-tension applied, by tightly fastening the nut is lost at least partially by turning back the nut and possibly a slight gap is created between the threaded nut and the adjacent structural component. This makes possible a slight axial play of the roll neck in the roll neck bearing which, in a subsequently carried out rolling process, produces the result that the roll neck can carry out an axial movement in the roll neck bearing for closing the gap, which leads to an increased wear.

The printed document U.S. Pat. No. 2,694,430 describes an arrangement of chain wheels which are mounted by means of conical roller bearings on a shaft. The bearing is secured against displacement by a partially slotted counter nut.

DE 1 254 108 relates to a roll neck bearing with a neck bushing slid onto the stepped neck. An axially secured external thread ring is arranged on a neck extension, wherein a ring nut securable axially relative to the neck is threaded on the external thread ring. In order to prevent a loosening of the ring nut during operation, the nut is secured in its position by means of a ring-shaped counter nut.

Moreover, for pulling the bearing units onto and from roll neck bearings, hydraulic pulling on and pulling off devices are known in practice which are mounted in the roll neck bearing or a bearing unit, which permanently remain at the roll neck bearing, and are coupled to external hydraulic sources for pulling the roll neck bearing on or off bearing units or for pulling bearing units off the roll neck. However, these devices for pulling the roll neck bearing or bearing units on and off, are complicated and expensive. The retrofitting of existing rolls, which merely use mechanically acting nuts for securing and fastening with such a device for pulling on or off, is only possible with substantial cost-intensive changes of the roll necks and/or with hydraulic devices adapted for this purpose. Accordingly this retrofitting cannot be realized economically.

Furthermore, hydraulic devices for pulling on and off which can be temporarily coupled to the bearing unit are known. Such a device is described, for example, in WO 2005/021175 A1. The device known from this reference is composed of a bearing unit which comprises a chock with a roll neck bearing arranged in the chock. The bearing unit is arranged on a neck of the back-up roll. A tension anchor, which extends in the axial direction of the roll, engages at the neck. On the tension anchor is mounted an axially displaceable screw cap disk which rests, on the one hand, on a nut which can be moved by being screwed on the tension anchor and, on the other hand, on the bearing unit. A hydraulic pre-tensioning tool can be fastened to the nut for applying a tensioning force between the tension anchor and the cap screw disk resting at the bearing unit. For mounting the bearing unit, a defined pre-tension is applied with the device on the tensioning anchor and subsequently the screw cap disk is mechanically tightened by hand by means of a threaded nut. Subsequently, the device is switched to pressureless operation, so that the pre-tension of the tension anchor is transmitted through the threaded nut to the roll bearing or a roll bearing unit. Because of the pretension, the threaded nut is secured against rotation to a certain extent on the external thread provided on the tension anchor or the roll neck. However, under the operating conditions of a hot or cold rolling mill this self-locking action is not always sufficient to prevent a loosening of the threaded nut and the occurrence of the above-described problems.

Therefore, the invention is based on the object to provide a solution which improves the self-locking security against rotation of the threaded nut which holds the roll neck bearing in position.

In a fastening system of the above-described type, this object is met by constructing at the threaded nut a partial section which is moveable by bending wherein the partial section is moveable, particularly bendable, into a position which produces in the adjacent thread a surface pressure which acts opposite the threaded nut relative to the remaining threaded engagement.

Because of the configuration of the threaded nut according to the invention with a partial section which is arranged on the nut, but is bendable and moveable by bending relative to the nut, the internal thread formed by the threaded nut is divided into two sections. One threaded section is located in the unscrewed position of the threaded nut on the outside on the side of the threaded nut facing away from the roll neck bearing, and the other section of the thread is the thread of the remaining section of the threaded nut. In the threaded nut tightened on the roll neck or the tension anchor, initially both threaded portions of the threaded nut are in engagement uniformly and in the same manner with the external thread formed on the tension anchor or the roll neck, wherein the meshing flank sides of the two inter-engaging threads produce on one side of the thread a surface pressure. When the partial section which is movable by bending is moved relative to the remaining section of the nut, for example, moved toward this remaining section, particularly is bent toward this part, the threaded partial section causes in the corresponding and contacting partial section of the external thread of the tension anchor or the roll neck, such a relative movement of the threads assigned to each other, that in this partial section the flank sides opposite the remaining threaded section consequently also cause an oppositely directed surface pressure. Accordingly, this produces a quasi “counter nut effect” which, with the partial section being appropriately tightly fastened causes a permanent frictional engagement together with the frictional coefficient in the threaded section of the remaining part of the threaded nut. This interaction of the two threaded section areas of the threaded nut results in a force and measure which safely counteracts the loosening of the threaded nut. The threaded nut is constructed because of this measure so as to be secured against rotation in a self-locking manner. This security against rotation is reinforced in the above-described manner of assembly by means of a hydraulic pulling on device which can be temporarily coupled to the roll bearing because the tension anchor is then under initial tension which pulls the threaded nut tightly against the roll neck bearing or the bearing unit, particularly a screw cap disk.

By bending the partial section which is moveable by bending relative to the remaining part of the threaded nut, at least in the transition area between the two elements, an offset of the internal thread in the sense of a position change of the pitch of the internal thread of the threaded nut, is effected. Depending on the thickness of the partial section, the oppositely directed surface pressure acting on the flanks may only be present over a portion of the longitudinal extension of the threaded part assigned to the partial section.

In order to be able to apply surface pressure directed in the opposite direction in accordance with the invention, it is advantageous according to an embodiment of the invention if the partial section which is moveable by bending extends over a partial circumferential area of the nut.

A particularly advantageous possibility for constructing the partial section which is moveable by bending according to a further development of the invention, exists when the partial section moveable by bending is a circular ring segment disk which is spaced from the adjacent area of the threaded nut by a slot which extends transversely, particularly perpendicularly, relative to the middle longitudinal axis of the threaded nut. Accordingly, the partial section which is moveable by bending can be manufactured relatively simply by placing a vertical cut in a threaded nut, and so that through a partial circumferential area of the threaded nut a disk in the form of a circular ring segment is formed which is then bendable relative to the remaining section of the threaded nut.

In order to be able to assign a substantial area of the internal threaded area so as to be displaceable, it is further advantageous if the slot extends at least up to the level of the roll neck or the tension anchor which is also provided for by the invention.

However, in order to be able to subject a particularly large area of the thread surface to the oppositely directed surface pressure, it is advantageous in accordance with a further development of the invention if the slot extends over the diameter of the roll neck or the tension anchor.

In accordance with a further development of the invention, particularly advantageous dimensions of the partial section which is moveable by bending are present if the partial section which is moveable by bending has a length corresponding to 5% to 30% of the total length of the threaded nut, and if the partial section which is moveable by bending forms a circular ring segment disk which extends over a circular circumference or angle section of between 180° and 300° in relation to the outer diameter of the threaded nut.

In order to be able to carry out the bending movement and to be able to secure and hold the bending which has been carried out, the invention further provides that at least one screw is guided through the partial section which engages in an adjacent area of the threaded nut arranged flush in alignment therewith.

In this connection it is additionally advantageous if the screw is secured against a loosening rotation by gluing the gear unit or by means of a wire safety means against a loosening rotation.

Particularly advantageous is a measure according to the invention in a roll bearing in which the tension anchor is arranged as to be secured against rotation in an end area of the roll neck.

In such a roll neck bearing it is further useful for the effect of the fastening system, according to the invention, if between the roll neck bearing and the threaded nut a screw cap disk is arranged between the roll neck bearing and the threaded nut so as to be axially slidable on the tension anchor or the roll neck, which the invention also provides for.

In accordance with a further development of the invention, the above-described effect of the fastening system is reinforced further by the fact that the screw cap disk, reinforced by a pre-tensioning force supported by the pre-tensioning force exerted by the tension anchor, rests against the roll neck bearing, on the one hand, and the threaded nut on the other hand.

For the effect of the fastening system it is further advantageous if the partial section is formed on the side of the threaded nut facing away from the roll neck bearing.

Finally, the invention also provides that the roll neck is a component of a back-up roll, because the fastening system according to the invention can be used especially in roll bearings of back-up rolls of hot or cold rolling mills.

If a roll neck bearing is to be used in a different type of machine, which also has the same features, the invention can also be used.

In the following the invention will be explained in more detail with the aid of an embodiment with reference to the corresponding drawing. In the drawing:

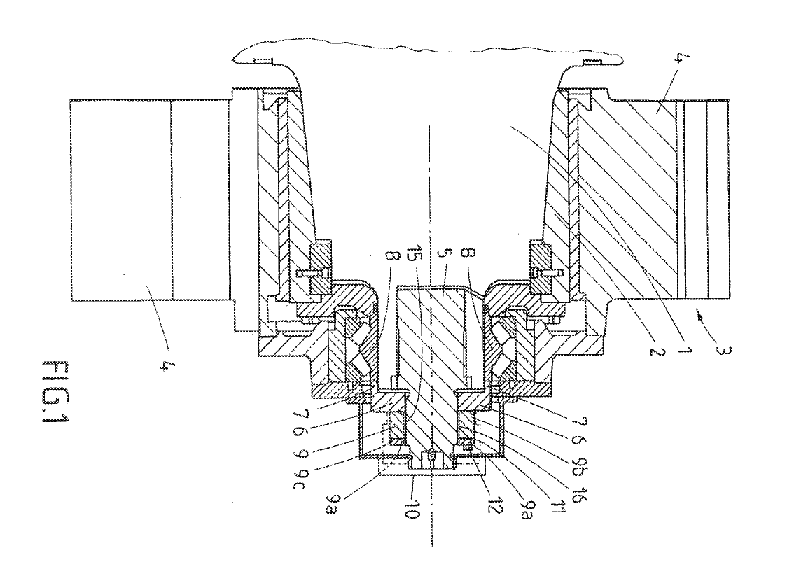

FIG. 1 is a schematic cross-sectional view of a roll bearing equipped with the fastening system according to the invention,

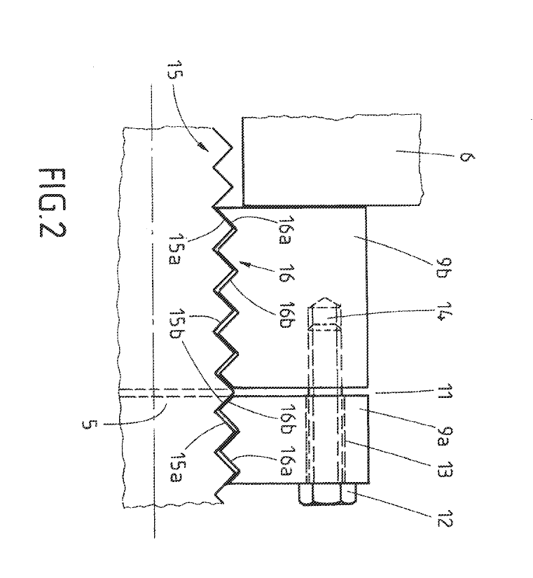

FIG. 2 is a schematic cross-sectional view of a tension anchor with threaded nut for explaining the effect of a partial section of a threaded nut which is movable by bending, and

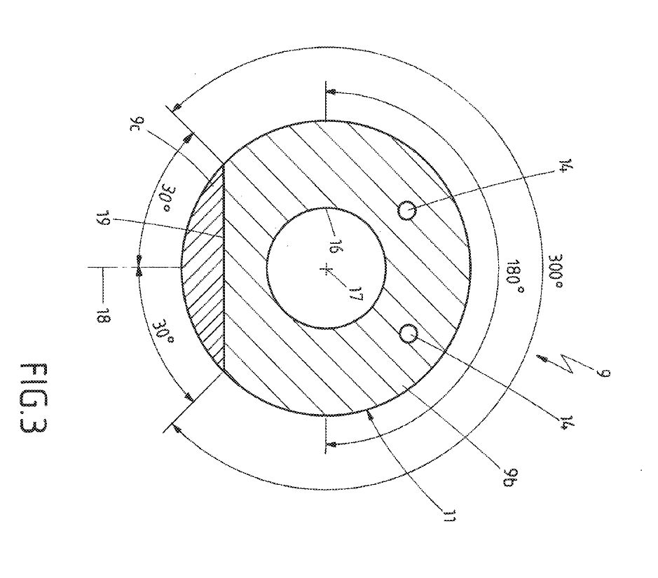

FIG. 3 is a schematic illustration showing a sectional view of a slot dividing the threaded nut.

FIG. 1 shows a roll neck 1 of a back-up roll of a hot or cold rolling mill or of another application of a roll neck bearing. A chock 4 of the roll bearing is pulled onto the roll neck 1 with a neck bushing 2 of a bearing unit 3. In its outer end area, the roll neck 1 has a central axially extending bore with internal thread into which is screwed a tension anchor 5 with a first external thread so as to be fixed against rotation. Especially in roll necks 1 consisting of cast material, which may have defect locations, a special thread can be used through which a uniform distribution of the tensile forces onto the individual threads is achieved. Arranged on the tension anchor 5 is a cup-shaped screw cap disk 6 so as to be rotatable and axially displaceable, wherein the rim 7 of the cup-shaped screw cap disk 6 rests against a roll neck bearing 8, here an axial pressure bearing, of the bearing unit 3. On an end of the tension anchor 5 protruding from the roll neck 1, the tension anchor 5 has a second external thread 15 onto which is screwed a threaded nut 9 with its internal thread 16.

The threaded nut 9 has a circular ring-shaped cross-section and an internal thread 16. By a slot 11 or incision, the threaded nut 9 is divided into a partial section 9a which is movable by bending and a remaining section 9b. The partial section 9a of the threaded nut 9 which is movable by bending, which in the state of assembly illustrated if FIGS. 1 and 2 is arranged at the outer end of the tension anchor 5, is constructed so as to be spaced by the slot 11 or the incision in the area of the slot 11 from the remaining section 9b. The slot 11 or incision is additionally constructed and arranged in such an area at least essentially perpendicularly of the longitudinal center axis of the threaded nut 9, such that the partial section 9a which is movable by bending extends over a partial circumferential area of the threaded nut 9 in the form of a circular ring segment disk. The slot 11 or the incision is constructed at least up to the level of the external thread 15 formed on the tension anchor 5 and in engagement with the threaded nut 9, but advantageously as seen in FIG. 1, with such a length that it extends over the entire diameter of the tension anchor 5 in the area of the external thread 15 which is in engagement with the threaded nut 9. As can be seen in FIG. 1 and FIG. 3, in the illustrated embodiment, only a circular partial ring-shaped section 9c remains through which the partial section 9a continues to be connected with the remaining section 9b of the threaded nut 9. This circular partial ring then essentially forms the counter bearing around which the partial section 9a can be bent for applying the surface pressure according to the invention which will be described in the following. Consequently, the slot 11 or incision extends over such a part of the diameter of the threaded nut 9 that the connecting piece 9c still remains between the partial section 9a and the remaining section 9b of the threaded nut. The dimensions of the connecting piece 9c are such that the resulting material area has sufficient strength for bearing and absorbing the bending stresses occurring during bending of the partial section 9a. The partial section 9a which is movable by bending extends over a length which is between 5% and 30% of the total length or depth of the threaded nut 9. The slot 11 or incision is constructed with such a length or depth that this results in a separation of a partial circumferential area of the threaded nut 9 forming the partial section 9a which is movable by bending as the circular ring segment disk, wherein the circular ring segment disk extends over a circular circumference of between 180° and approximately 300° in relation to the outer diameter of the threaded nut 9 (see FIG. 3). The width of the slot 11 or incision is constant and is, for example, between 5 and 25 mm. The slot 11 is manufactured, for example, by means of a saw, milling cutter or a laser.

FIG. 3 is a sectional view of a slot 11 as a partial illustration of a top view of a partial section 9b. The surface resting against the slot 11 is illustrated with wide hatching and the intersecting surface through the connecting piece 9c is illustrated with narrow hatching. The slot 11 extends over a circle circumference or angle section of 300° in relation to the outer diameter of the threaded nut 9. The remaining connecting piece extends over a circular circumference or angle section of a total of 60°, uniformly by about 30° on both sides of a principal axis 18, each in relation to the external diameter of the threaded nut 9, extending through the center point 17. With respect to manufacturing technology, along the line 19 shown in dash-dot lines and defines the connecting piece 9c, initially a bore is made in the threaded nut 9, before the slot 11 is cut into the threaded nut 9 precisely up to this bore.

In the partial section 9a which is movable by bending, throughbores 13 are made parallel to the center longitudinal axis of the threaded nut 9, wherein bores 14 with internal threads are formed in the area of the remaining section 9b of the threaded nut 9 in alignment with the throughbores 13. A screw 12 with a threaded head is guided through each throughbore 13 and is screwed into the corresponding bore 14. The number of screws 12 depends on the partial circumferential area of the threaded nut 9 over which the partial section 9a extends.

FIG. 1 also further shows a cover 10 which protects the neck area of the bearing unit 3 during operation, and which is supported so as to be removable or pivotable for pulling the bearing unit 3 on or off from the roll neck 1.

A hydraulic pre-tensioning tool, as it is described, for example, in WO 2005/021175 A1, is temporarily assignable to the threaded nut 9. This pre-tensioning tool operates as follows: The pre-tensioning tool rests on the tension anchor 5 and moves the screw cap disk 6 against the roll neck bearing 8. Simultaneously, the neck bushing 2 is pushed onto the neck 1. When the neck bushing 2 sits tightly on the roll neck 1, further pressure is applied to the pre-tensioning tool, so that the tension anchor is extended elastically. After reaching a pre-determined elastic elongation, the threaded nut 9 is manually placed against the screw cap disk 6. After the hydraulic pressure has been switched off from the pre-tensioning tool, the tension anchor 5 fixedly connected to the roll neck 1, particularly non-rotatably, relative to each other, pulls the roll neck bearing 8 over the threaded nut 9 and the screw cap disk with the appropriately adjusted elastic pre-tension of the tension anchor 5 onto the roll neck 1. The pre-tensioning tool is removed and the screws 12 are tightened in such a way that the partial section 9a which is movable by bending is moved on the remaining section 9b of the threaded nut 9 arranged at the distance opposite the partial section 9a and as a result is bent to a certain extent. This then creates the oppositely directed surface pressure in the area of the threads 15 and 16 assigned to the partial section 9a.

Accordingly, the resulting non-rotatable arrangement of the threaded nut 9 on the external thread of the tension anchor 5 by means of a surface pressure causing a permanent frictional engagement, comprises two types of operation. As can be seen in FIG. 2, the pre-tension tension anchor 5 presses the threaded nut 9 against the screw cap disk 6, so that the flanks 15a of the external thread 15 of the tension anchor 5 and the flanks 16a of the internal thread 16 of the threaded nut 9 and the remaining section 9b rest against each other with surface pressure causing a frictional engagement. In contrast, by moving the partial section 9a toward the remaining section 9b of the threaded nut 9, in the partial areas of the conical threads 15, 16 assigned to the partial section 9a, a surface pressure is effected at the respectively other sides of the flanks of a thread, namely the flanks 15b of the external thread 15 of the tension anchor 5 and the flanks 16b of the internal thread 16 of the threaded nut 9 in the partial section 9a. As a result, a partial section 9a which is movable by bending is formed on the threaded nut 9, wherein the partial section 9a is movable, particularly bendable, relative to the remaining section 9b of the threaded nut 9 into a position which produces a surface pressure 15b, 16b which is directed opposite the remaining threaded engagement of the threaded nut 9. Consequently, through the threads of the thread flanks 15a, 16a, on the one hand, and 15b, 16b, on the other hand, the threaded nut 9 is tightly clamped onto the tension anchor 5 and is secured so as to be non-rotatable. The areas of the threads which are in engagement with each other and produce a surface pressure with frictional engagement are illustrated in FIG. 2 in bold lines.

For securing the partial section 9a which is movable by bending in the bent position causing the surface pressure, the screws 12 are secured against rotation by means of an adhesive in the respective bore 14 or by means of wire. When tightening the screws 12, there is no danger that the threaded nut 9, which is already held with pre-tension on the tension anchor 5, rotates, nor is such a rotation necessary for facilitating the screwing in of the screws 12.

For disassembling the roll neck bearing or the bearing unit 3, the screws 12 are loosened, the tension anchor 5 is loosened once again by means of the pre-tensioning tool, and then the threaded nut 9 is loosened and is removed. The hydraulic unit is then switched to being without pressure and reset for reverse operation for pulling off the roll neck bearing or the bearing unit.

1-10. (canceled)

11. A fastening system of a roll bearing, comprising: a bearing unit; a roll neck supported in the bearing unit in a roll neck bearing; and a threaded nut engaging into a thread formed on the roll neck or on a tension anchor and securing the bearing unit on the roll neck; a partial section, movable by bending, formed on the threaded nut, wherein the partial section is movable relative to a remaining section of the threaded nut into a position for producing a surface pressure that acts opposite a threaded engagement of the threaded nut in an adjacent thread, the partial section which is movable by bending being a circular ring segment disk that is spaced from an adjacent area of the threaded nut by a slot that extends transversely of a center axis of the threaded nut, wherein the slot extends beyond a diameter of the roll neck or of the tension anchor; and at least one screw is guided through the partial section and engages in a threaded bore arranged in alignment with the screw in the adjacent area of the threaded nut.

12. The fastening system according to claim 11, wherein the partial section which is movable by bending extends over a partial circumferential area of the threaded nut.

13. The fastening system according to claim 11, wherein the partial section which is movable by bending has a length corresponding to 5% to 30% of a total length of the threaded nut.

14. The fastening system according to claim 11, wherein the partial section which is movable by bending forms a circular ring segment disk that extends over a circular circumference or angle section between 180° and 300° in relation to an external diameter of the threaded nut.

15. The fastening system according to claim 14, wherein the screw is secured against a loosening rotation.

16. The fastening system according to claim 15, wherein the screw is secure by gluing of the thread.

17. The fastening system according to claim 15, wherein the screw is secured by a wire securing mechanism.

18. The fastening system according to claim 11, wherein the tension anchor is arranged so as to be secured against co-axial rotation in an end area of the roll neck.

19. The fastening system according to claim 11, further comprising a screw cap disk arranged between the roll neck bearing and the threaded nut, the screw cap disk being axially slidably mounted on the tension anchor or the roll neck.

20. The fastening system according to claim 19, wherein the screw cap disk is supported by a pre-tensioning force exerted by the tension anchor relative to the roll neck bearing, on the one hand, and the threaded nut on the other hand.

21. The fastening system according to claim 11, wherein the partial section is constructed on a side of the threaded nut facing away from the roll neck bearing.

22. The fastening system according to claim 11, wherein the roll neck is part of a back-up roll.
